(19) United States
(12) Patent Application Publication
(10) Pub. No.: US 2010/0038828 A1
(43) Pub. Date: Feb. 18, 2010

(54) Moulding method using microwaves

(75) Inventor: Douglas John McNally, Chatham (CA)

Correspondence Address: Anissimoff & Associates, Suite 201, 235 North Centre Road, London, ON, N5X 4E7, CA

(73) Assignee: KONAL ENGINEERING AND EQUIPMENT, INC., Blenheim (CA)

(21) Appl. No.: 12/461,595

(22) Filed: Aug. 18, 2009

Related U.S. Application Data
(60) Provisional application No. 61/136,196, filed on Aug. 18, 2008.

(51) Int. Cl. H05B 6/64

(52) U.S. Cl. 264/460; 264/489

(57) ABSTRACT

A method of moulding products made of expanded polymer beads using steam. The steam is generated by introducing a quantity of water into a mould that is capable of being pressurized. Steam is created by way of exposing the mould to microwave irradiation and the temperature of the steam is directly controlled by the pressure inside the mould.

### BACKGROUND OF THE INVENTION

1. Field of the Invention

The present invention relates to a method of moulding products from expanded polymer beads using steam inside a pressurized mould wherein the steam is generated by microwave irradiation.

2. Prior Art

The current method for moulding products made of expanded polymer beads or the like is energy inefficient and complicated due to the use of steam. The process starts by blowing beads of the plastic material, such as polypropylene or polystyrene, into a mould. Steam is then injected into the mould to melt the contents. Specifically, the steam heats the beads to their thermoset temperature at which their exteriors begin to melt and ‘stick’ together. The mould and its contents are then cooled. As the mould temperature falls below the thermoset temperature of the beads the exteriors of the beads harden and they remain fused to each other in the shape of the mould.

The object of the invention is to provide a way to reduce the energy consumption during the heating step and to provide a more flexible method of manufacturing while maintaining the same quality of product.

### SUMMARY OF INVENTION

A method of moulding products made of expanded polymer material using is disclosed. Polymer particles are introduced into a mould capable of being pressurized along with a quantity of water for conversion into steam. The mould contents are pressurized to a selected pressure and the mould is exposed to microwave irradiation to convert the water into steam at a selected temperature. The temperature of the steam may be controlled by controlling the pressure inside the mould. The generated steam inside the mould melts the polymer particles into a product.

According to another aspect of the invention a pressure chamber may be used. According to this aspect an unpressurized mould is placed inside a pressure chamber and the pressure is thereby controlled.

### BRIEF DESCRIPTION OF THE DRAWINGS

A preferred embodiment of the invention is described by way of example with reference to the accompanying drawing, in which

FIG. 1 illustrates the following steps:

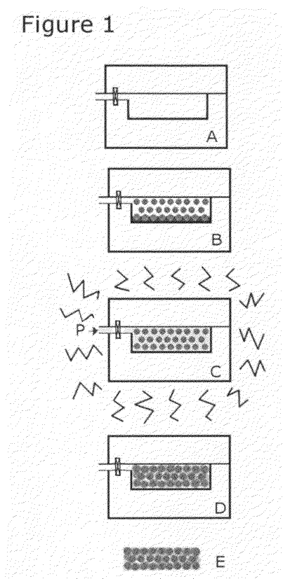

A. a mould capable of being pressurized

B. the mould shown in A filled with expandable polymer material together with a quantity of water.

C. The mould shown in B pressurized to a pressure P and exposed to microwave irradiation to create steam.

D. The mould shown in C wherein the material has cooled and the pressure has been released.

E. The product made from the mould of expanded polymer material.

### DETAILED DESCRIPTION

The moulding method according to the present invention uses microwave irradiation to transform water in the mould into steam. The temperature of the steam, and as a direct consequence the mould contents is controlled by the pressure inside the mould.

At the start of the process plastic beads are introduced into the mould by means of, for example, blowing. A quantity of water, preferably preheated, is introduced into the mould either during the introduction of the beads into the mould or separately. The mould is then sealed to enable it to become a pressure chamber. Alternatively, an unpressurized mould and contents can be placed inside a larger pressure chamber to control pressure inside the mould.

Microwave irradiation is used to generate steam and heat the contents of the mould. Increasing the pressure inside the mould raises the temperature at which the water inside the mould will boil and sets the temperature of the steam that will be created inside the mould. Therefore, by controlling the pressure inside the mould, the temperature of the superheated steam obtained can be precisely controlled to efficiently heat the beads to their thermoset temperature. In essence, the elevated pressure used in the mould defines the temperature of the steam according to well established and readily available steam table data.

The pressure, amount of irradiation and amount of water are preferably selected and controlled such that the quantity and temperature of the steam created causes the exterior of the beads to reach their thermoset temperature at which the exteriors of the beads begin to melt and ‘stick’ together. Guidelines for selecting steam temperature may be preferably transposed from existing and prior art steam moulding methods and refined according to moulding results and experience. The optimum temperature of a selected bead material is an important guide in selected the desired steam temperature.

After the desired temperature is reached and held for a specific amount of time, the mould and its contents are cooled and returned to atmospheric pressure. The product made by this process is equal in density and quality to products created by the prior art means of steam injection. The process itself requires less energy, and is mechanically simplified by the elimination of the need to transport steam and inject it to the required location.

One example of a method according to the present invention is the use of a mould container which is filled with the appropriate plastic beads and a specific amount of water. The mould container is placed inside a microwave in a pressure chamber and the contents irradiated. After the contents have cooled, an expanded polystyrene block or product shaped like the inside of the mould container is obtained. This product is equal in density and quality to products manufactured using steam injection.

The key aspect of the present invention is the creation of steam inside a pressurized mould wherein the temperature of the steam is controlled by selecting the pressure inside the mould.

Further advantages which are inherent in the valve stem puller may be obvious to those skilled in the art. The embodiment described herein is for illustration as is not meant to limit the scope of the invention as claimed. Variations of the forgoing embodiment will be evident to a person of ordinary skill and are intended by the inventor to be encompassed by the following claims.

1. A method of moulding products made of expanded polymer material using steam comprising:
a) introducing polymer particles into a mould capable of being pressurized
b) introducing a quantity of water into the mould for conversion into steam
c) pressurizing the contents of the mould to a selected pressure
d) exposing the mould to microwave irradiation to convert the said water into steam at a resultant temperature whereby the temperature of the steam is controlled by controlling the pressure inside the mould
e) using the generated steam inside the mould to melt the polymer particles into a product

2. A method of moulding products made of expanded polymer material using steam comprising:
a) introducing polymer particles into a mould
b) introducing a quantity of water into the mould for conversion into steam
c) pressurizing the contents of the mould to a selected pressure by placement of the mould inside a pressure chamber
d) exposing the mould to microwave irradiation to convert the said water into steam at a resultant temperature whereby the temperature of the steam is controlled by controlling the pressure inside the mould
e) using the generated steam inside the mould to melt the polymer particles into a product.
